(19) United States
(12) Patent Application Publication
(10) Pub. No.: US 2026/0210271 A1
(43) Pub. Date: Jul. 23, 2026

(54) ANNULAR WALL OF AERONAUTICAL TURBINE ENGINE AND AERONAUTICAL TURBINE ENGINE COMPRISING SUCH A WALL

(71) Applicant: SAFRAN AIRCRAFT ENGINES, PARIS (FR)

(72) Inventors: Jose Luis GONZALEZ GARCIA, MOISSY-CRAMAYEL (FR); Alexandre Gérard François COUILLEAUX, MOISSY-CRAMAYEL (FR); Mathieu Frédéric LASNE, MOISSY-CRAMAYEL (FR); Philippe Gérard CHANEZ, MOISSY-CRAMAYEL (FR)

(73) Assignee: SAFRAN AIRCRAFT ENGINES, PARIS (FR)

(21) Appl. No.: 19/564,867

(22) Filed: Mar. 12, 2026

Related U.S. Application Data
(63) Continuation of application No. PCT/FR2024/051178, filed on Sep. 9, 2024.

(30) Foreign Application Priority Data
Sep. 13, 2023 (FR) 23/09642

(51) Int. Cl. F01D 25/14

(52) U.S. Cl. CPC F01D 25/14; F05D 2220/323; F05D 2240/14; F05D 2260/213

(57) ABSTRACT

An annular wall of an aeronautical turbine engine includes an axis and an aerodynamic surface extending axially along and circumferentially about the axis, and configured to delimit a gas passage. The wall includes a concavity extending radially from the aerodynamic surface and provided with a heat exchanger having a heat exchanger matrix and an aerodynamic profile. A heat transfer fluid circuit extends at least into the heat exchanger matrix. The matrix has a first portion housed in the concavity and a second portion extending radially outside the concavity and projecting radially from the aerodynamic surface. The aerodynamic profile includes a leading edge and a trailing edge, and is fixed to the second portion of the heat exchanger matrix such that the leading edge and the trailing edge extend circumferentially and the leading edge is radially spaced from the aerodynamic surface and outside the concavity.

### CROSS-REFERENCE TO RELATED APPLICATIONS

This application is a continuation of International Application No. PCT/FR2024/051178, filed on Sep. 9, 2024, which claims priority to and the benefit of FR 23/09642, filed on Sep. 13, 2023. The disclosures of the above applications are incorporated herein by reference.

### FIELD

The present disclosure relates to an annular wall of an aeronautical turbine engine and an aeronautical turbine engine comprising such a wall.

### BACKGROUND

The statements in this section merely provide background information related to the present disclosure and may not constitute prior art.

The term “aeronautical turbine engine” refers to all gas turbine devices producing motive power, among which we distinguish in particular turbojet engines providing a thrust desired for the propulsion by reaction to the high-speed ejection of gas, and turboshaft engines in which the motive power is supplied by the rotation of a drive shaft. For example, turboshaft engines are used as engines for helicopters. As another example, turboprop engines (turboshaft engines driving a propeller) are turboshaft engines used as airplane engines.

The aeronautical turbine engines generally feature heat exchangers on annular walls radially delimiting a gas passage in order to cool a fluid, usually oil, which serves to cool and/or lubricate various components of the turbine engine, for example, bearings or other rotating elements. Such an example is known from WO2023/001379.

Among known heat exchangers, there are two main families, namely air cooled oil coolers, also known by the acronym ACOC, and surface air cooled oil coolers, also known by the acronym SACOC. The ACOC heat exchangers are generally thermally efficient, but generate significant pressure losses in the gas flow path and cause increases in static pressure that degrade the performance of upstream components. The SACOC heat exchangers generate lower pressure losses, but are less thermally efficient.

In view of climate change, restrictions on carbon emissions are a constant concern for the Owner of the present disclosure. Therefore, in order to obtain aeronautical components and turbine engines that are as energy-efficient and environmentally friendly as possible, with a view to reducing the environmental impact of the aeronautical sector, in particular the civil aviation sector, the Owner takes into account all elements that may have an impact in this respect, and in particular heat exchangers.

### SUMMARY

This section provides a general summary of the disclosure and is not a comprehensive disclosure of its full scope or all of its features.

A variation relates to an annular wall of an aeronautical turbine engine, the wall having an axis and comprising an aerodynamic surface extending axially along the axis and circumferentially about the axis, the aerodynamic surface being configured to radially delimit a gas flow passage, the wall having a concavity extending radially from the aerodynamic surface, the wall being provided with a heat exchanger comprising a heat exchanger matrix and an aerodynamic profile, a heat transfer fluid circuit extending at least within the heat exchanger matrix, the heat exchanger matrix comprising a first portion housed in the concavity and a second portion extending radially outside the concavity and projecting radially from the aerodynamic surface, the aerodynamic profile having a leading edge and a trailing edge, the aerodynamic profile being fixed to the second portion of the heat exchanger matrix such that the leading edge and the trailing edge extend circumferentially and that the leading edge is radially spaced from the aerodynamic surface and outside (i.e., external to) the concavity.

The heat exchanger may be regarded as an element mounted on the annular wall. In other words, the variation defined above may be viewed as an assembly comprising the annular wall and the heat exchanger.

In general, the axial direction corresponds to the direction of the axis of the annular wall, which, when the latter is mounted on an aeronautical turbine engine, corresponds to the axis of rotation of the gas generator. A radial direction is a direction perpendicular to the axis/axial direction. The azimuthal or circumferential direction corresponds to the direction describing a ring about the axis/axial direction. The three axial, radial, and azimuthal (or circumferential) directions correspond respectively to the directions defined by the height, the radius, and the angle in a cylindrical coordinate system. Furthermore, upstream and downstream are defined with respect to the normal flow direction of the fluid (from upstream to downstream) through the aeronautical turbine engine. Finally, unless otherwise specified, the adjectives inner/internal and outer/external are used with reference to the radial direction, such that the inner (i.e., radially inner) part of an element is closer to the axis defining the axial direction than the outer (i.e., radially outer) part of the same element.

Hereinafter, and unless otherwise specified, the term “wall” should be understood “annular wall of an aeronautical turbine engine”, the term “exchanger” should be understood “heat exchanger”, the term “matrix” should be understood “heat exchanger matrix”, and the term “profile” should be understood “aerodynamic profile”. As a reminder, the term “matrix” refers to, for those skilled in the art, an effective part of the exchanger, comprising channels in which the heat transfer fluid circulates in order to exchange heat with the fluid surrounding the matrix.

The annular wall may be an annular sector or a complete ring. The complete ring may be formed by a ring manufactured in one single piece, or by a plurality of annular sectors. The heat exchanger may extend continuously over the entire circumferential extent of the annular wall, or only over annular sectors spaced apart from one another in the circumferential direction. In the latter case, the aerodynamic profile may have the same circumferential extent as that of the heat exchanger matrix, or it may have a circumferential extent greater than the heat exchanger matrix, for example, by extending symmetrically by the same circumferential extent on each side of the heat exchanger matrix. According to one variant, the matrix may extend only over annular sectors spaced apart from one another in the circumferential direction, whereas the profile may extend continuously over the entire circumferential extent of the wall and be fixed to all the annular sectors of the matrix.

The annular wall may be a radially inner wall or a radially outer wall of a gas flow path, or may also be an outer wall of a nacelle, such an outer wall delimiting the external gas flow passage of the nacelle (i.e., the air passage flowing about the nacelle). The concavity may extend radially inward if the annular wall is a radially inner wall, or an outer wall of a nacelle. The concavity may extend radially outward if the annular wall is a radially outer wall. When the concavity extends radially outward, the second portion of the heat exchanger matrix protrudes radially inward relative to the annular wall. When the concavity extends radially inward, the second portion of the heat exchanger matrix protrudes radially outward relative to the annular wall.

The heat transfer fluid may be a fuel or a lubricant, for example, oil, but not necessarily.

For example, the leading edge and the trailing edge of the aerodynamic profile may extend parallel to the aerodynamic surface of the wall. The opposite sides of the profile in the radial direction may respectively form a pressure side and a suction side extending from the leading edge to the trailing edge. For example, the pressure side of the aerodynamic profile may be fixed to the matrix. For example, the trailing edge may be radially spaced from the aerodynamic surface and located outside the concavity. For example, the entire aerodynamic profile may be radially spaced from the aerodynamic surface and arranged outside the concavity.

As seen from the gas flow circulating along the wall, the heat exchanger comprises a “concealed” portion within the wall, corresponding to the first portion of the matrix disposed within the concavity, and a projecting portion from the wall, corresponding to the second portion of the matrix provided with the aerodynamic profile. Since the leading edge of the profile is radially spaced from the wall, it may guide a portion of the gas flow toward the concavity and toward the matrix. Such guidance is less intrusive and less constraining for the gas flow than a prior art flow deflection, which reduces pressure losses and static pressure rises induced by the heat exchanger.

Such a configuration may therefore make it possible to obtain satisfactory thermal efficiency through the combined use of the matrix and the profile, which also participates in heat exchange, while reducing pressure losses as much as possible.

For example, the flow cross-section considered at the trailing edge between the wall and the profile is greater than the flow cross-section considered at the leading edge between the wall and the profile. This may make it possible to reduce as much as possible the disturbance induced in the gas flow and the pressure losses.

In some variations, the heat exchanger may comprise at least one fin extending radially from the aerodynamic profile and axially along the aerodynamic profile, opposite the heat exchanger matrix.

Hereinafter, unless otherwise specified, “fin” should be understood “the at least one fin”.

The fin may extend perpendicularly to the profile, for example on its suction side, between the leading edge and the trailing edge. The fin may make it possible to improve heat exchange, for example by convection, while inducing, due to its extent parallel to the direction of the gas flow, very little disturbance within the gas flow. In other words, combining the fins on the profile with the matrix makes it possible to increase heat exchange with minimal pressure loss and without the heat exchanger occupying significantly more space on the wall. With the fins, substantially the same length and circumferential extent as the matrix alone are obtained, but greater heat exchange is achieved by means of the fins with less additional height than would be desired by increasing the matrix.

In some variations, the heat transfer fluid circuit may extend within the aerodynamic profile.

By “within the aerodynamic profile”, it should be understood that the heat-transfer fluid circuit extends within the volume of the profile itself, between the pressure side, the suction side, the leading edge and the trailing edge.

In some variations, the heat-transfer fluid circuit may extend within the wall.

By “within the wall”, it should be understood within the volume of the wall itself, and not within an element mounted on the wall such as the heat exchanger.

In some variations, the heat-transfer fluid circuit may extend within the at least one fin.

By “within the at least one fin”, it should be understood within the volume of at least one of the fins, and not within an adjacent element such as the profile.

Such a fluid circuit according to one or another or a combination of the configurations described above may make it possible to improve heat exchange without impacting the pressure loss induced by the exchanger.

For example, the heat exchanger may be manufactured in whole or in part by additive manufacturing. This may make it possible, on the one hand, to improve the external geometric shape of the exchanger and, on the other hand, the heat-transfer fluid circuit extending within the exchanger.

In some variations, the heat exchanger may extend only over annular sectors circumferentially spaced apart from one another.

In other words, when considered in the circumferential direction, the adjacent annular sectors of the exchanger are spaced apart from one another. Each annular sector has a limited circumferential extent, each sector being distinct from the other sectors. The annular sectors may be regularly distributed in the circumferential direction. According to one variant, all annular sectors of the exchanger may be arranged at the same axial position, such that they are all aligned in the circumferential direction.

An exchanger comprising such annular sectors may exhibit a satisfactory thermal efficiency while reducing the induced pressure loss.

In some variations, a ratio between a maximum axial length of the aerodynamic profile and a maximum axial length of the heat exchanger matrix may be comprised between 1.0 and 1.4, for example between 1.2 and 1.3.

In some variations, a ratio between a maximum radial thickness of the aerodynamic profile and a maximum radial thickness of the heat exchanger matrix may be comprised between 0.05 and 0.35, for example between 0.10 and 0.25.

Such ratios may make it possible to provide a good balance between the thermal efficiency of the exchanger and the disturbance induced in the gas flow.

In some variations, the aerodynamic profile may have an airfoil profile shape.

An airfoil profile shape may have a rounded leading edge, i.e. having a non-zero radius, without geometric discontinuity or angle. For example, an airfoil profile shape may be a profile shape of the “NACA” type.

Such an airfoil profile shape may make it possible to deflect a portion of the gas flow toward the matrix while reducing the disturbance induced in this flow, and in particular the pressure loss.

A variation relates to an aeronautical turbine engine comprising an annular wall of an aeronautical turbine engine according to any one of the variations

### Described in the Present Disclosure.

The aeronautical turbine engine may be a ducted or unducted turbojet engine. For example, the fan may be driven directly by a gas generator or via a speed reduction gearbox. For example, the fan diameter, considered at the tip of the fan blades at the leading edge, may be comprised between 50.8 cm and 508 cm (or between 20 inches and 200 inches). For example, the by-pass ratio, also known by the acronym BPR, which corresponds to the ratio of the mass flow rate of the secondary air flow (i.e. the gas flow from the fan that does not enter the gas generator) divided by the mass flow rate of the primary air flow (i.e. the gas flow from the fan that enters the gas generator), may be comprised between 8 and 40, for example between 8 and 18 for ducted fans, and for example between 18 and 40 for unducted fans. For example, the fan pressure ratio, also known by the acronym FPR, which corresponds to the pressure ratio between the inlet of the fan module upstream of the fan and the outlet of the fan module downstream of the guide vanes, may be comprised between 1.0 and 1.5.

In some variations, the aeronautical turbine engine may comprise a hot gas flow path and a cold gas flow path, in which the wall radially delimits at least a portion of the cold gas flow path.

The hot gas flow path is sometimes referred to those skilled in the art as the “primary flow path”, whereas the cold gas flow path is sometimes also referred to those skilled in the art as the “secondary flow path”.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an aircraft equipped with an aircraft turbine engine,

FIG. 2 schematically shows the main internal components of the aircraft turbine engine of the aircraft of FIG. 1,

FIG. 3 schematically shows different annular walls of the aircraft turbine engine of the aircraft of FIG. 1,

FIG. 4 shows in greater detail an annular portion of the heat exchanger of FIG. 3, in perspective view,

FIG. 5 shows a first variant of the heat exchanger, and

FIG. 6 shows a second variant of the heat exchanger.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

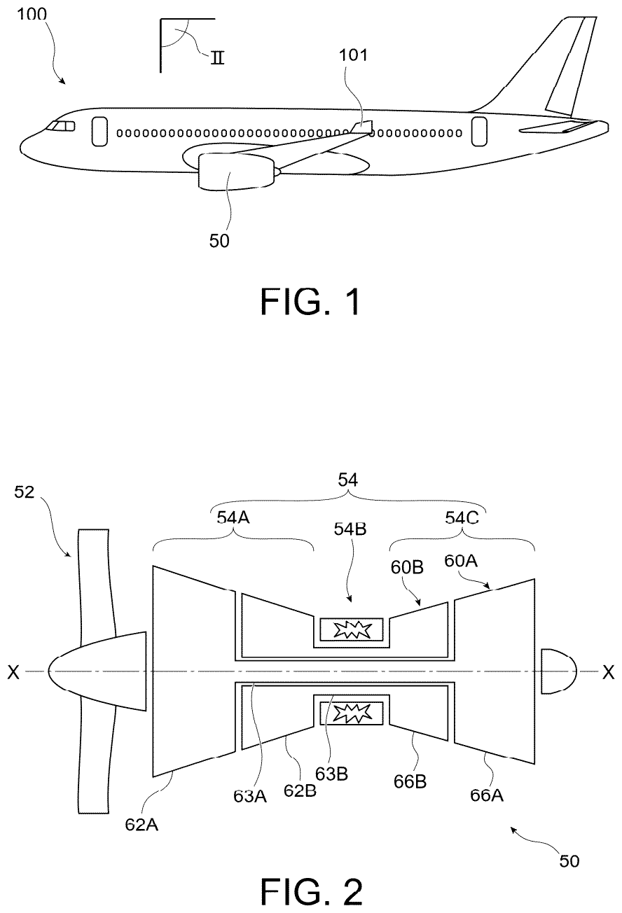

FIG. 1 shows an aircraft 100, in this example an airplane, equipped with two aircraft turbine engines 50, in this example two propulsion units 50, in this example two turbojet engines 50, namely one aircraft turbine engine 50 per wing 101, only one aircraft turbine engine 50 and a single wing 101 being shown in FIG. 1. According to one variant, the aircraft 100 may be equipped with more than one aircraft turbine engine 50 per wing 101, each wing 101 being provided with the same number of aircraft turbine engines 50.

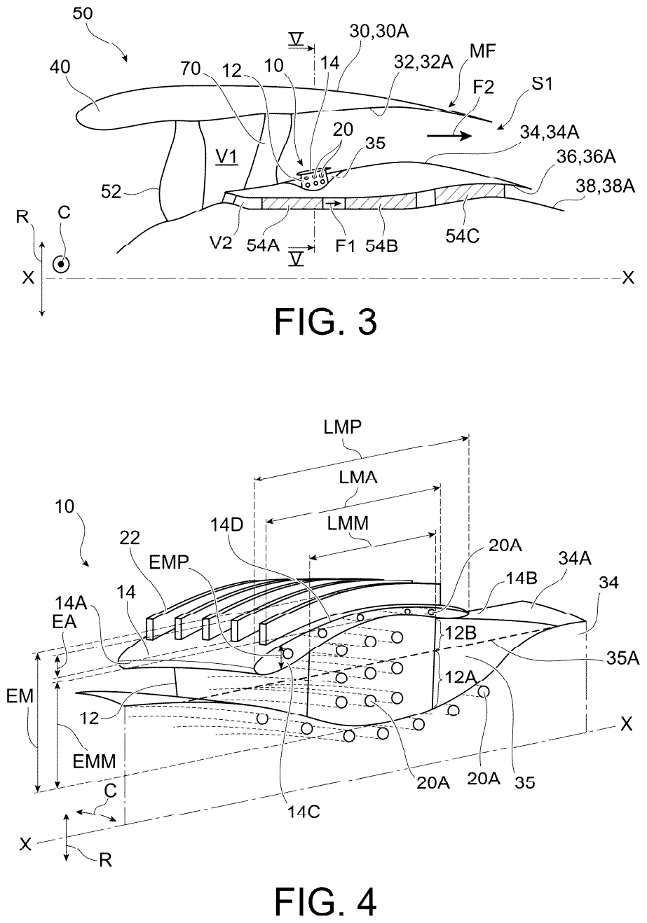

FIG. 2 shows a schematic sectional view of the main internal components of the aircraft turbine engine 50, along the plane II of FIG. 1. The aircraft turbine engine 50 comprises a fan 52, which may be ducted or unducted, and a gas generator 54 having an axis of rotation X. In the example of FIG. 1, the fan is ducted, the duct not being shown in FIG. 2 but being shown in FIG. 3. In this example, the gas generator 54 comprises, from upstream to downstream, the gases flowing within the aircraft turbine engine 50 from upstream to downstream, a compressor 54A (or compressor section 54A), a combustion chamber 54B, and a turbine 54C (or turbine section 54C). The fan 52 may be driven in rotation directly by a shaft of the gas generator 54, for example a shaft of a low-pressure spool, or via a speed reduction gearbox not shown.

The gas generator 54 may be of the dual-spool type and comprise a low-pressure spool 60A and a high-pressure spool 60B. The low-pressure spool 60A may comprise a low-pressure compressor 62A rotationally coupled with a low-pressure turbine 66A via a low-pressure shaft 63A. The high-pressure spool 60B may comprise a high-pressure compressor 62B arranged downstream of the low-pressure compressor 62A and upstream of the combustion chamber 54B, and a high-pressure turbine 66B arranged downstream of the combustion chamber 54B and upstream of the low-pressure turbine 66A, and rotationally coupled with the high-pressure compressor 62B via a high-pressure shaft 63B. The compressor 54A of the gas generator 54 may comprise the low-pressure and high-pressure compressors 62A and 62B. The turbine 54C of the gas generator 54 may comprise the low-pressure and high-pressure turbines 66A and 66B. FIG. 2 is schematic, each compressor and each turbine possibly comprising one or more stages, each stage comprising a movable wheel and a stator or guide vanes.

FIG. 3 shows a schematic sectional view of the aircraft turbine engine 50, along the plane II of FIG. 1, illustrating the annular walls of the turbine engine 50. The compressor 54A, in particular the rotating and stationary blades, the combustion chamber 54B, and the turbine 54C, in particular the rotating and stationary blades, are represented by hatched areas. The gas generator 54 is not shown in greater detail for the sake of clarity of the figure.

In the example of FIG. 3, the turbine engine 50 is provided with five annular walls 30, 32, 34, 36 and 38 having axis X and respectively comprising aerodynamic surfaces 30A, 32A, 34A, 36A and 38A extending axially along the axis X and circumferentially about the axis X (i.e. in the circumferential direction C). The annular wall 30 is an outer nacelle wall 40 and delimits the gas flow passage external to the nacelle 40. The walls 32 and 34 delimit a cold gas flow path (or passage) V1, whereas the walls 36 and 38 delimit a hot gas flow path (or passage) V2. The wall 32 is a radially outer wall of the cold gas flow path V1, whereas the wall 34 is a radially inner wall of the cold gas flow path V1. The wall 36 is a radially outer wall of the hot gas flow path V2, whereas the wall 38 is a radially inner wall of the hot gas flow path V2. When the turbine engine 50 is operating, the hot gas flow path V2 is configured to guide a so-called primary gas flow F1, and the cold gas flow path V1 is configured to receive a so-called secondary gas flow F2.

In the example of FIG. 3 (see also FIG. 4), the annular wall 34 has a concavity 35 extending radially (i.e. in the radial direction R) from the aerodynamic surface 34A. The wall 34 is provided with a heat exchanger 10 comprising a heat exchanger matrix 12 and an aerodynamic profile 14. A heat-transfer fluid circuit 20 extends at least within the heat exchanger matrix 12. In this example, the circuit 20 is symbolized by channels 20A and may also extend within the wall 34 and/or within the profile 14. The heat exchanger matrix 12 comprises a first portion 12A housed in the concavity 35 and a second portion 12B extending radially outside the concavity 35 and protruding radially relative to the aerodynamic surface 34A. In FIG. 4, the orifice of the cavity 35 is symbolized by a dashed line 35A extending in the geometric continuation of the upstream and downstream portions of surface 34A with respect to the cavity 35. The line 35A represents the radial limit of the concavity 35. The aerodynamic profile 14 comprises a leading edge 14A and a trailing edge 14B, the aerodynamic profile 14 being fixed to the second portion 12B of the heat exchanger matrix 12 such that the leading edge 14A and the trailing edge 14B extend circumferentially and such that the leading edge 14A is radially spaced from the aerodynamic surface 34A and located outside the concavity 35. In other words, in this example, the leading edge 14A is arranged outside the concavity 35 and adjoins the line 35A or is radially spaced from the line 35A in a radial direction R. In this example, the trailing edge 14B is also radially spaced from the aerodynamic surface 34A and located outside the concavity 35. In this example, the entire profile 14 is arranged outside the concavity 35. In this example, the wall 34 forms a wall radially delimiting at least a portion of the cold gas flow path V1. In this example, the concavity 35 and the exchanger 10 are arranged downstream of the guide vanes 70, itself arranged downstream of the fan 52, and upstream of the outlet S1 of the fan module MF, the fan module MF comprising the fan 52, the guide vanes 70 and the nacelle 40.

As can be seen in FIG. 4, the leading edge 14A and the trailing edge 14B of the aerodynamic profile 14 may extend parallel to the aerodynamic surface 34A of the wall 34 in the circumferential direction C. In this example, the profile 14 comprises a pressure side 14C and a suction side 14D, each extending between the leading edge 14A and the trailing edge 14B and forming two opposite faces in the radial direction R of the profile 14. In this example, the profile 14 is fixed to the matrix 12 via the pressure side 14C. In this example, the profile 14 has an airfoil profile shape. In this example, the leading edge 14A has a rounded shape, i.e. having a non-zero radius, without geometric discontinuity or angle.

As can be seen in FIG. 4, the heat exchanger 10 may comprise at least one fin 22 extending radially from the aerodynamic profile 14 and axially along the aerodynamic profile 14, opposite the heat exchanger matrix 12. The heat-transfer fluid circuit 20 may extend within all or part of the fins 22 (not shown).

For example, a ratio LMP/LMM between a maximum axial length of the aerodynamic profile LMP and a maximum axial length of the heat exchanger matrix LMM may be comprised between 1.0 and 1.4, for example between 1.2 and 1.8.

In this example, the maximum axial length of the matrix LMM may be comprised between 5.0 cm and 25.5 cm (or between 2 inches and 10 inches), whereas the maximum axial length of the profile LMP may be comprised between 5.0 cm and 25.5 cm (or between 2 inches and 10 inches). The maximum axial length of the matrix LMM may be less than or equal to the maximum axial length of the profile LMP. The maximum axial length LMA of the fins 22 may be less than or equal to the maximum axial length of the profile LMP and greater than or equal to the maximum axial length of the matrix LMM.

For example, a ratio EMP/EMM between a maximum radial thickness of the aerodynamic profile EMP and a maximum radial thickness of the heat exchanger matrix EMM may be comprised between 0.05 and 0.35, for example between 0.10 and 0.25. It is noted that the axial position of the maximum radial thickness of the profile 14 and the axial position of the maximum radial thickness of the matrix 12 do not necessarily coincide, as illustrated in the example of FIG. 4.

In the example of FIG. 4, the radial thickness EA of each fin 22 is constant over the entire axial extent of the fins 22 and may be comprised between 1.25 cm and 5.00 cm (or between 0.5 inch and 2.0 inches). According to a non-illustrated variant, the radial thickness EA of the fins 22 may vary in the axial direction X, and the average value of the radial thickness EA may be comprised between 1.25 cm and 5.00 cm (or between 0.5 inch and 2.0 inches).

The maximum radial thickness of the heat exchanger EM, including the optional fins 22, may be comprised between 5.0 cm and 13.0 cm (or between 2 inches and 5 inches).

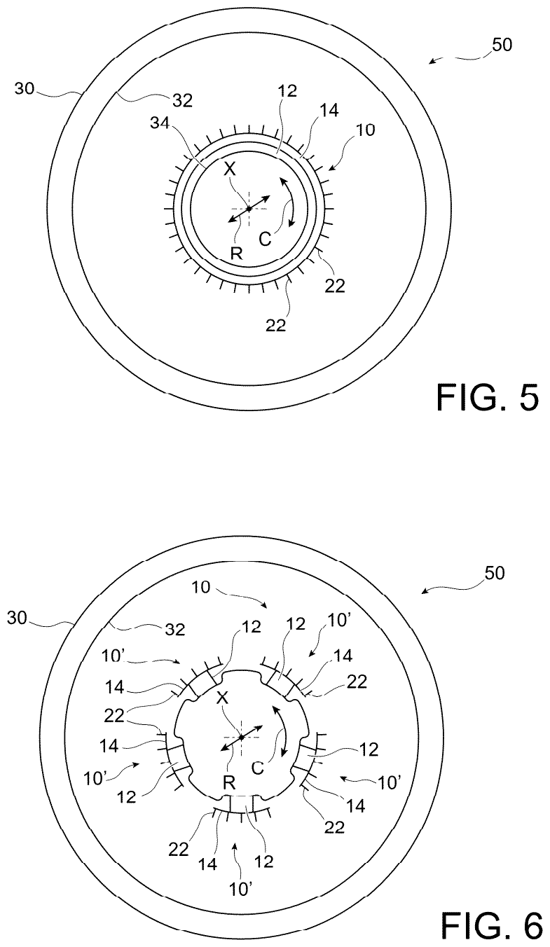

FIG. 5 illustrates a first variant according to the sectional plane V of FIG. 5, in which the exchanger 10, in particular the matrix 12 and the profile 14, extends continuously over the entire circumferential extent of the wall 34. FIG. 6 illustrates a second variant according to sectional plane V of FIG. 5, in which the heat exchanger 10, in particular the matrix 12 and the profile 14, extends only over annular sectors 10′ circumferentially spaced from one another. In this second variant, the annular sectors 10′ are regularly spaced from one another. In other words, the angular sectors 10′ are regularly distributed in the circumferential direction C. As can be seen in FIG. 6, for each annular sector 10′, the circumferential extent of the profile 14 is greater than the circumferential extent of the matrix 12. In this example, the profile 14 extends circumferentially beyond the matrix 12 by the same amount on each side of the matrix 12.

The heat-transfer fluid circulating in the circuit 20 may be a lubricant, for example oil, which may serve, for example, for lubricating and/or cooling one or more bearings (not shown) of one or both of the low-pressure and high-pressure shafts 63A, 63B. Alternatively or in addition, the oil may serve, for example, for lubricating and/or cooling a possible reduction gearbox coupling in rotation the low-pressure shaft 63A and the fan 52.

In the examples described above, only the wall 34 is provided with a concavity 35 housing a heat exchanger 10. According to a non-illustrated variant, in addition to or instead of the wall 34, the wall 30 and/or the wall 32 and/or the wall 36 and/or the wall 38 may be provided with a concavity housing a heat exchanger, in a manner similar to the concavity 35 and the exchanger 10 described with reference to FIGS. 3 to 6. For example, in the case where the wall 36 and/or the wall 38 defining the hot gas flow path are provided with a concavity housing a heat exchanger, the concavity and the exchanger may, for example, be arranged upstream of the compressor 54A.

In the examples described above, the wall 34 being a radially inner wall, the concavity 35 extends radially inwardly and the exchanger 10, in particular the second portion 12B of the matrix 12, projects radially outwardly relative to the wall 34. Similarly, in the case where the wall 30 or the wall 38 is provided with a concavity and an exchanger, the concavity extends radially inwardly and the exchanger, in particular the second portion of the matrix, projects radially outwardly relative to the wall 30 or 38, respectively. Conversely, in the case where the wall 32 or the wall 36, which are radially outer walls, are provided with a concavity and an exchanger, the concavity extends radially outwardly and the exchanger, in particular the second portion of the matrix, projects radially inwardly relative to the wall 32 or 36, respectively.

Although the present disclosure has been described with reference to specific variations, it is evident that modifications and changes may be made to these examples without departing from the general scope of the disclosure as defined by the claims. In particular, individual features of the different illustrated/mentioned variations may be combined in additional variations. Consequently, the description and the drawings should be considered illustrative rather than restrictive.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An annular wall of an aeronautical turbine engine, the annular wall having an axis and comprising an aerodynamic surface extending axially along the axis and circumferentially about the axis, the aerodynamic surface being configured to radially delimit a gas passage, the annular wall having a concavity extending radially from the aerodynamic surface, the annular wall being provided with a heat exchanger comprising a heat exchanger matrix and an aerodynamic profile, a heat transfer fluid circuit extending at least into the heat exchanger matrix, the heat exchanger matrix having a first portion housed in the concavity and a second portion extending radially outside the concavity and projecting radially from the aerodynamic surface, the aerodynamic profile having a leading edge and a trailing edge, the aerodynamic profile being fixed to the second portion of the heat exchanger matrix such that the leading edge and the trailing edge extend circumferentially and that the leading edge is radially spaced from the aerodynamic surface and outside the concavity, wherein the heat exchanger comprises at least one fin extending radially from the aerodynamic profile, opposite the heat exchanger matrix, and axially along the aerodynamic profile, the heat transfer fluid circuit extending within the aerodynamic profile.

2. The annular wall of the aeronautical turbine engine according to claim 1, wherein the heat transfer fluid circuit extends into the annular wall.

3. The annular wall of the aeronautical turbine engine according to claim 1, wherein the heat exchanger extends only over annular sectors circumferentially spaced from one another.

4. The annular wall of the aeronautical turbine engine according to claim 1, wherein a ratio between a maximum axial length of the aerodynamic profile and a maximum axial length of the heat exchanger matrix is between 1.0 and 1.4.

5. The annular wall of the aeronautical turbine engine according to claim 1, wherein a ratio between a maximum radial thickness of the aerodynamic profile and a maximum radial thickness of the heat exchanger matrix is between 0.05 and 0.35.

6. The annular wall of the aeronautical turbine engine according to claim 1, wherein the aerodynamic profile has an airfoil profile shape.

7. An aeronautical turbine engine comprising the annular wall of the aeronautical turbine engine according to claim 1.

8. The aeronautical turbine engine according to claim 7, comprising a hot gas flow path and a cold gas flow path, wherein the annular wall radially delimits at least a portion of the cold gas flow path.
